(19) United States
(12) Patent Application Publication
(10) Pub. No.: US 2020/0172743 A1
(43) Pub. Date: Jun. 4, 2020

(54) ACID INDICATOR SYSTEM

(71) Applicant: Covestro Deutschland AG, Leverkusen (DE)

(72) Inventors: Jan WEIKARD, Leverkusen (DE); Lydia KRÖGER, Köln (DE); Emma Jeanne Pauline RUIZ, Andolsheim (FR)

(21) Appl. No.: 16/639,158

(22) PCT Filed: Aug. 13, 2018
(86) PCT No.: PCT/EP2018/071889

§ 371 Date: Feb. 14, 2020

(30) Foreign Application Priority Data
Aug. 16, 2017 (EP) 17186369.9

(51) Int. Cl. C09D 7/41; C09D 5/29; C09D 175/06; C09D 175/14; C09D 175/02; C09D 7/65; C09D 7/62; C09B 11/00; G01N 21/78

(52) U.S. Cl. CPC C09D 7/41; C09D 5/29; C09D 175/06; C09D 175/14; G01N 21/78; C09D 7/65; C09D 7/62; C09B 11/00; C09D 175/02

(57) ABSTRACT

The invention relates to an indicator system, a method for optically displaying the progress of curing a composition, the use of colourants with a xanthene skeleton to optically display the progress of curing compositions, a kit-of-parts, and a method for increasing the clock rate between a coating step and an additional, downstream processing step for objects.

The invention relates to an indicator system, to a method for optically indicating the curing progress of a composition, to the use of dyes with xanthene skeleton for optically indicating the curing progress of compositions, to a kit of parts, and to a method for increasing the cycle frequency between a coating step and a further downstream step of processing objects.

In coating operations there is a need to progress them as quickly and hence cost-effectively as possible. An advantage here is if there is an easy means of determining whether a coating material already possesses the degree of curing desired for further processing. Especially in the case of nonautomated coating operations, which are subject to a host of variables influencing the curing process, such as ambient temperature, atmospheric humidity, air movement, substrate temperature, and coating material temperature, for example, and in the context, for example, of automotive refinishing, a reliable indication of the degree of curing is important. For example, contact between the not yet fully cured finish on an automobile always harbors the risk of damage to the soft coating film. Curing ought therefore to be indicated contactlessly, by a change in color, for example. In order not to alter the decorative aspect of the finish, the color change ought always to entail the disappearance of the visible coloration—in other words, in the cured coating film, the dye ought to be colorless.

WO 2003/062287 describes adhesives based on acrylates and/or methacrylates, these adhesives curing through influence of UV light and bearing a dye which changes color in the course of curing by radical polymerization induced by UV light. Both xanthene and anthraquinone dyes are disclosed as classes of dye. A disadvantage is that the dye used as indicator is always added to the adhesive, so limiting its use to chemically compatible compositions, and meaning that the possibilities of use are very restricted.

WO 2009/127182 discloses curable compositions prepared from at least one polyol component and at least one isocyanate component, and comprising a color indicator for indicating the progress of curing. Color indicators used are dyes which have a nonaromatic quinoid group. A disadvantage is that the dyes used retain a coloring after the composition has cured, and therefore color said composition, so ruling out their use in colorless curable mixtures, such as clearcoats, for example.

WO 2009/47663 describes a system for skin sealing with a film-forming polymer, the system comprising an indicator dye which changes color when the applied composition undergoes a change in phase. Film-forming polymers referred to are cyanoacrylate adhesives curing by radical polymerization, tosylamide-formaldehyde adhesives, epoxy-based adhesives, and film formers which cure through solvent evaporation but are not described any further. Indicator dyes disclosed are various fluorescein derivatives, which are added to the applied composition. The main disadvantage is that the fluorescein derivatives used also strongly color the cured composition so ruling out their use in clearcoats.

Disadvantages of the indicator dyes disclosed in the prior art, therefore, are that they are not colorless in the cured composition, so ruling out their use in colorless coatings such as clearcoats, for example; cannot be employed in basic systems; or that the dyes used are used only in compositions which cure by radical polymerization. There is therefore no foreseeable possibility for use in compositions which cure by a polyaddition reaction, as in the case of polyurethane-forming compositions, for example, because of the continual risk here that the dye may be consumed by reaction with reactive components and hence that the optical indication of the curing progress may be distorted.

It was an object of the present invention, accordingly, to provide an indicator system which reliably indicates the curing, even of a basic composition comprising isocyanate-containing and isocyanate-reactive components, through a visible change in color, without coloring the composition in the cured state.

It has surprisingly been found that the stated object can be achieved through the indicator system of the invention, in which the dye used as indicator may optionally be applied on an inert carrier.

The invention accordingly provides an indicator system comprising a composition which comprises at least one NCO-reactive compound and at least one polyisocyanate, and comprising at least one proton source and at least one indicator dye, the at least one indicator dye having at least one xanthene skeleton, for indicating the curing of the composition by change in color of the at least one indicator dye, characterized in that the at least one indicator dye, has a first color after contacting with the uncured composition and in the cured composition is colorless.

In one preferred embodiment of the indicator system of the invention, the at least one indicator dye and the at least one proton source are applied on a surface of an inert carrier, the inert carrier optionally being applied with a second surface, which faces away from the first surface, on a second inert carrier, the second carrier preferably being selected from the group consisting of polymer foils, metal foils, paper and/or card, and the inert carrier being colorless and transparent, and the second carrier preferably being white.

In one preferred embodiment of the indicator system of the invention the at least one indicator dye has at least one fluoran skeleton, and preferably is selected from the group of fluorescein derivatives and rhodamine derivatives which are able to form a spirolactone form, and/or mixtures of at least two thereof.

In one preferred embodiment of the indicator system of the invention, the at least one proton source is a Brønsted acid, preferably a nonpolymeric acid, more preferably a nonpolymeric, film-forming acid.

In one preferred embodiment of the indicator system of the invention, the Brønsted acid is selected from the group consisting of nonpolymeric carboxylic acids, hydroxycarboxylic acids, phosphoric and sulfonic acids with organic substitution, and/or mixtures of at least two thereof.

In one preferred embodiment of the indicator system of the invention, the at least one polyisocyanate in the composition is an aliphatic and/or cycloaliphatic polyisocyanate, the polyisocyanate preferably being selected from the group consisting of derivatives of hexamethylene diisocyanate and/or of pentamethylene diisocyanate.

In one preferred embodiment of the indicator system of the invention, the at least one NCO-reactive compound is selected from the group consisting of polyaspartic esters, polyacrylate polyols, polyester polyols, and/or mixtures of at least two thereof.

In one preferred embodiment of the indicator system of the invention, the composition is a polyurethane and/or polyurea coating material, preferably a polyurethane and/or polyurea refinish clearcoat, more particularly a refinish clearcoat based on polyaspartic ester derivatives.

Likewise provided by the invention is a method for optically indicating the curing progress of a composition which comprises at least one NCO-reactive compound and at least one polyisocyanate, characterized in that the method comprises the following steps:
(a) providing at least one indicator dye and at least one proton source, the at least one indicator dye having at least one xanthene skeleton, and the at least one indicator dye and the at least one proton source being applied on a surface of an inert carrier,
(b) contacting the at least one indicator dye and the at least one proton source from step (a) with the uncured composition, the at least one indicator dye having a first color, and
(c) curing the composition, the at least one indicator dye indicating the curing of the composition through color switch from the first color to colorless.

In one preferred embodiment of the method of the invention, the inert carrier is a polymer foil or a glass fiber web, preferably a polymer foil, more particularly a polyethylene terephthalate or polycarbonate foil.

In one preferred embodiment of the method of the invention, the inert carrier, by a second surface, which faces away from the first surface, is applied on a second inert carrier, the second carrier preferably being selected from the group consisting of polymer foils, metal foils, paper and/or card, and the inert carrier being colorless and transparent, and the second carrier preferably being white.

Likewise provided by the invention is a method for optically ascertaining the curing progress of a composition comprising at least one NCO-reactive compound and at least one polyisocyanate, with at least one indicator dye and at least one proton source, the at least one indicator dye having at least one xanthene skeleton, characterized in that, after contacting of the at least one indicator dye and of the at least one proton source with the composition, the color of the at least one indicator dye is compared with a color scale in order to ascertain the curing progress.

Likewise provided by the invention is the use of an indicator dye with xanthene skeleton, preferably with fluoran skeleton, in the presence of at least one proton source, for optically indicating the curing progress of compositions comprising at least one NCO-reactive compound and at least one polyisocyanate, characterized in that the at least one indicator dye has a first color after contacting with the uncured composition and in the sufficiently cured composition is colorless, the composition preferably being a polyurethane coating material, more preferably a polyurethane refinish clearcoat, more preferably still a refinish clearcoat based on polyaspartic ester derivatives.

Likewise provided by the invention is a kit of parts comprising at least one indicator dye, the at least one indicator dye having at least one xanthene skeleton, at least one proton source, a composition comprising at least one NCO-reactive compound and at least one polyisocyanate, the at least one indicator dye and the at least one proton source preferably being applied on a surface of an inert carrier, the inert carrier preferably being applied by a second surface, which faces away from the first surface, on a second inert carrier, the second carrier preferably being white.

Likewise provided by the invention is a method for increasing the cycle frequency between a coating step and a further downstream step in the processing of objects which are coated with a composition which comprises at least one NCO-reactive compound and at least one polyisocyanate, characterized in that at least one indicator dye is contacted with the composition in the presence of at least one proton source in order to indicate the curing progress of the coating, the at least one indicator dye having at least one xanthene skeleton.

The word “a/one” in the context of the present invention in connection with countable parameters is to be understood as meaning the number “one” only when this is stated explicitly (for instance by the expression “precisely one”). When reference is made hereinbelow for example to “a polyisocyanate” the word “a” is to be understood as meaning merely the indefinite article and not the number one, and this also therefore encompasses an embodiment in which two or more, for example structurally dissimilar, polyisocyanates are present.

An NCO-reactive compound is understood to mean a compound that can react with polyisocyanates to give polyaddition compounds, especially polyurethanes, under conditions customary in coating technology. Suitable NCO-reactive compounds used may be any compounds known to those skilled in the art that have a mean OH, SH and/or NH functionality of at least 1.5. These may, for example, be low molecular weight diols (e.g. ethane-1,2-diol, propane-1,3- or -1,2-diol, butane-1,4-diol), triols (e.g. glycerol, trimethylolpropane) and tetraols (e.g. pentaerythritol), polyaspartates, polythiols, but also polyhydroxyl compounds such as polyether polyols, polyester polyols, polyurethane polyols, polysiloxane polyols, polycarbonate polyols, polybutadiene polyols, polyacrylate polyols and/or polymethacrylate polyols and copolymers thereof, called polyacrylate polyols hereinafter.

In one preferred embodiment, the at least one NCO-reactive compound is a polyhydroxyl compound. Suitable polyhydroxyl compounds preferably have mass-average molecular weights Mw>500 daltons, measured by means of gel permeation chromatography (GPC) according to DIN 55672-1:2016-03 in tetrahydrofuran at 25° C. against a polystyrene standard, more preferably between 800 and 100 000 daltons, especially between 1000 and 50 000 daltons. Suitable polyhydroxyl compounds preferably have an OH number of 30 to 400 mg KOH/g, especially between 100 and 300 KOH/g. The hydroxyl number (OH number) indicates how many mg of potassium hydroxide are equivalent to the amount of acetic acid bound by 1 g of substance in the acetylation. For the determination, a sample of the polyhydroxyl compound is heated with acetic anhydride/pyridine, and the acid formed is titrated with potassium hydroxide solution (DIN EN ISO 4629-2:2016). The glass transition temperatures, measured with the aid of DSC measurements according to DIN-EN-ISO 11357-2:2014, of the polyhydroxyl compounds are preferably between −150 and 100° C., more preferably between −120° C. and 80° C.

Suitable polyether polyols are obtainable in a manner known per se by alkoxylation of suitable starter molecules under base catalysis or by the use of double metal cyanide compounds (DMC compounds). Examples of suitable starter molecules for the production of polyether polyols are simple low molecular weight polyols, water, organic polyamines having at least two N—H bonds, or any mixtures of such starter molecules.

Preferred starter molecules for the production of polyether polyols by alkoxylation, in particular by the DMC process, are in particular simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol, and low-molecular-weight hydroxyl-containing esters of such polyols with dicarboxylic acids of the type specified hereinafter by way of example, or low-molecular-weight ethoxylation or propoxylation products of such simple polyols, or any desired mixtures of such modified or unmodified alcohols. Alkylene oxides suitable for the alkoxylation are in particular ethylene oxide and/or propylene oxide, which may be used in the alkoxylation in any order or also in a mixture.

In one preferred embodiment, the at least one NCO-reactive compound is a polyaspartic ester of the general formula (I),

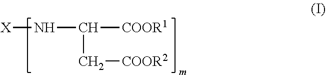

in which X is an m-valent organic radical, optionally containing one or more heteroatoms, as may be obtained by removal of the primary amino group or groups from a corresponding monoamine or polyamine from the molecular weight range 60 to 6000 that has (cyclo)aliphatically and/or araliphatically bonded primary amino groups, and that may contain further functional groups which are reactive toward isocyanate groups and/or are inert at temperatures up to 100° C.,

R1 and R2 are identical or different organic radicals, preferably identical or different alkyl radicals each having 1 to 18 carbon atoms, and very preferably identical or different alkyl radicals each having 1 to 8 carbon atoms, and

m is an integer >1, preferably ≥2, and more preferably =2.

Polyaspartic esters are prepared preferably from amines by addition to activated C—C double bonds by methods that are known per se and have been described. Examples of compounds which can preferably be used are ethylenediamine, 1,2-diaminopropane, 1,4-diaminobutane, 2,5-diamino-2,5-dimethylhexane, 1,5-diamino-2-methylpentane (Dytek® A, DuPont), 1,6-diaminohexane, 2,2,4- and/or 2,4,4-trimethyl-1,6-diaminohexane, 1,11-diaminoundecane, 1,12-diaminododecane, or triaminononane.

Likewise possible for use are relatively high molecular weight polyether polyamines having aliphatically bonded, primary amino groups, of the kind sold for example under the Jeffamin® designation by Huntsman. Examples of diamines which can be used with particular preference are 1-amino-3,3,5-trimethyl-5-aminomethylcyclohexane (IPDA), 2,4- and/or 2,6-hexahydrotolylenediamine (H 6TDA), isopropyl-2,4-diaminocyclohexane and/or isopropyl-2,6-diaminocyclohexane, 1,3-bis-(aminomethyl)cyclohexane, 2,4′- and/or 4,4′-diamino-dicyclohexylmethane, 3,3′-dimethyl-4,4′-diaminodicyclohexylmethane (Laromin® C 260, BASF SE), the isomers of diaminodicyclohexylmethanes carrying a methyl group as ring substituents (=C-monomethyldiaminodicyclohexylmethanes), 3(4)-aminomethyl-1-methylcyclohexylamine (AMCA), and araliphatic diamines, such as, for example, 1,3-bis-(aminomethyl)benzene. Suitable reaction partners for the aminic components to be used for preparing the polyaspartates are preferably esters of maleic or fumaric acid. Examples of suitable compounds are dimethyl maleate, diethyl maleate, di-n-propyl maleate or isopropyl maleate, di-n-butyl maleate, di-2-ethylhexyl maleate, or the corresponding fumaric esters, and also mixtures of the aforesaid compounds. Especially suitable polyaspartic esters are sold under the Desmophen® NH designation by Covestro AG, Germany. #

Additionally suitable for preparing polyaspartic esters are amine-functional polymers which can be prepared by partial reaction of the aforesaid diamines with difunctional compounds suitable for polyaddition, such as diisocyanates or diacrylates, for example. It is also possible to increase the molecular weight of the aforesaid polyaspartic esters through partial reaction with diisocyanates. Suitable diisocyanates are butane 1,4-diisocyanate, pentane 1,5-diisocyanate (pentamethylene diisocyanate, PDI), hexane 1,6-diisocyanate (hexamethylene diisocyanate, HDI), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′- and 4,4′-MDI or mixtures of at least two thereof), diisocyanatomethylbenzene (tolylene 2,4- and 2,6-diisocyanate, TDI), and technical-grade mixtures of the two isomers, and also 1,3- and/or 1,4-bis(isocyanatomethyl)benzene (XDI), 3,3′-dimethyl-4,4′-biphenyl diisocyanate (TODI), para-phenylene 1,4-diisocyanate (PPDI), tetramethylxylylene 1,3-diiscyanates (TMXDI) and also cyclohexyl diisocyanate (CHDI) and the oligomers of higher molecular weight that are obtainable individually or in a mixture from the above but are difunctional and have uretdione, allophanate, urethane, and carbodiimide/uretonimine structural units. Preference is given to using aliphatic and cycloaliphatic diisocyanates, more particularly HDI, PDI, H12MDI, and IPDI.

Suitable polyester polyols are described, for example, in EP-A-0 994 1 17 and EP-A-1 273 640. Polyester polyols can be produced in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, hutanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. It is moreover also possible to polycondense hydroxycarboxylic acid derivatives, for example lactic acid, cinnamic acid or ω-hydroxycaproic acid to form polyester polyols. However, it is also possible to use polyester polyols of oleochemical origin. Such polyester polyols can be produced, for example, by full ring-opening of epoxidized triglycerides of an at least partly olefinically unsaturated fatty acid-containing fat mixture containing one or more alcohols having 1 to 12 carbon atoms and by subsequent partial transesterification of the triglyceride derivatives to alkyl ester polyols having 1 to 12 carbon atoms in the alkyl radical.

Suitable polyurethane polyols are preferably produced by reaction of polyester polyol prepolymers with suitable di- or polyisocyanates and are described, for example, in EP-A-1 273 640.

Suitable polysiloxane polyols are described, for example, in WO-A-01/09260, and the polysiloxane polyols cited therein can preferably be used in combination with further polyhydroxyl compounds, especially those having higher glass transition temperatures.

In one preferred embodiment, the at least one NCO-reactive compound is a polyacrylate polyol. Suitable polyacrylate polyols are generally copolymers and preferably have mass-average molecular weights Mw of between 1000 and 20 000 daltons, especially between 5000 and 10 000 daltons, measured in each case by means of gel permeation chromatography (GPC) according to DIN 55672-1:2016-03 in tetrahydrofuran at 25° C. against a polystyrene standard. The glass transition temperature of the copolymers is preferably between −100° C. and 100° C., especially between −50° C. and 80° C. (measured by means of DSC measurements according to DIN EN ISO 11357-2:2014). Suitable polyacrylate polyols preferably have an OH number of 60 to 250 mg KOH/g, especially between 70 and 200 mg KOH/g, and an acid number of between 0 and 30 mg KOH/g. The acid number here indicates the number of mg of potassium hydroxide which is used for neutralization of 1 g of the respective compound (DIN EN ISO 2114:2000).

The production of suitable polyacrylate polyols is known to those skilled in the art. They are obtained by radical polymerization of olefinically unsaturated monomers having hydroxyl groups or by radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate.

Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

In a further embodiment, the at least one NCO-reactive compound takes the form of aqueous dispersion. Examples are the abovementioned polyester and/or polyacrylate polyols which have been rendered dispersible with water through incorporation of emulsifying groups and/or through use of emulsifiers. With regard to the polyacrylate polyols, suitability is possessed both by emulsion polymers, where the polymerization takes place in micelles in aqueous phase, and secondary dispersions, for which a polymer is first prepared in bulk or in a little organic solvent and is then dispersed in water. Aqueous polyurethane polyol dispersions are likewise suitable.

Likewise suitable are hydroxyl-terminated polycondensates obtainable by reaction of diols or else lactone-modified diols or else bisphenols, for example bisphenol A, with phosgene or carbonic diesters such as diphenyl carbonate or dimethyl carbonate. Examples include the polymeric carbonates of hexane-1,6-diol, pentane-1,5-diol and/or butane-1,4-diol with an average molecular weight of ≥500 g/mol to ≤8000 g/mol, and also the carbonates of reaction products of hexane-1,6-diol with ε-caprolactone in a molar ratio of ≥0.1 to ≤1. Preference is given to aforementioned polycarbonate diols with an average molecular weight of ≥800 g/mol to ≤3000 g/mol, based on hexane-1,6-diol, and/or to carbonates of reaction products of hexane-1,6-diol with ε-caprolactone in a molar ratio of ≥0.33 to ≤1. Hydroxyl-terminated polycarbonates are available for example under the Desmophen® C designation from Covestro AG, DE, or under the Eternacoll® designation from Ube Industries, Ltd., JP.

Additionally suitable are hydroxy-terminated polybutadiene polymers of the kind sold for example by Cray Valley, FR under the poly-bd® designation.

The at least one NCO-reactive compound is preferably selected from the group consisting of polyaspartic esters, polyacrylate polyols, polyester polyols, and/or mixtures of at least two thereof; more particularly polyacrylate polyols, polyaspartic esters, and/or mixtures thereof.

Suitable polyisocyanates are any polyisocyanates known to those skilled in the art to be suitable for the production of polyisocyanate polyaddition products, especially polyurethanes, especially the group of the organic aliphatic, cycloaliphatic, araliphatic and/or aromatic polyisocyanates having at least two isocyanate groups per molecule, and mixtures thereof. Examples of polyisocyanates of this kind are di- or triisocyanates, for example butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′- and 4,4′-MDI or mixtures thereof), diisocyanatomethylbenzene (tolylene 2,4- and 2,6-diisocyanate, TDI) and technical grade mixtures of the two isomers, and also 1,3- and/or 1,4-bis(isocyanatomethyl)benzene (XDI), 3,3′-dimethyl-4,4′-biphenyl diisocyanate (TODI), paraphenylene 1,4-diisocyanate (PPDI), tetramethylxylylene 1,3-diisocyanates (TMXDI) and cyclohexyl diisocyanate (CHDI) and the oligomers of higher molecular weight that are obtainable individually or in a mixture from the above and have biuret, uretdione, isocyanurate, iminooxadiazinedione, allophanate, urethane and carbodiimide/uretonimine structural units. Preference is given to the use of polyisocyanates based on aliphatic and cycloaliphatic diisocyanates.

In one preferred embodiment, the at least one polyisocyanate is an aliphatic and/or cycloaliphatic polyisocyanate. In another preferred embodiment, the at least one polyisocyanate is a derivative of hexamethylene diisocyanate and/or of pentamethylene diisocyanate, especially a hexamethylene diisocyanate trimer and/or a pentamethylene diisocyanate trimer. In another preferred embodiment, the at least one polyisocyanate may contain one or more hydrophilizing groups such as, for example, polyethylene oxide units or neutralized sulfonate groups.

The ratio of polyisocyanates to NCO-reactive compounds, based on the amounts of substance of the polyisocyanate groups relative to the NCO-reactive groups, is preferably from 0.5:1.0 to 3.0:1.0. Particular preference is given to a ratio of 0.9:1.0 to 1.5:1.0 Very particular preference is given to a ratio of 1.05:1.0 to 1.25:1.0

In one preferred embodiment, the composition of the indicator system of the invention comprises at least one NCO-reactive compound selected from the group consisting of polyaspartic esters, polyacrylate polyols, polyester polyols and/or mixtures of at least two thereof and at least one polyisocyanate, the polyisocyanate being a derivate of hexamethylene diisocyanate and/or of pentamethylene diisocyanate. In another preferred embodiment, the composition comprises polyacrylate polyol as NCO-reactive compound, and as polyisocyanate a derivative of hexamethylene diisocyanate and/or of pentamethylene diisocyanate. In another preferred embodiment, the composition comprises polyacrylate polyol as NCO-reactive compound, and as polyisocyanate a hexamethylene diisocyanate trimer and/or a pentamethylene diisocyanate trimer. In another preferred embodiment, the composition comprises polyaspartic esters as NCO-reactive compound, and as polyisocyanate a derivative of hexamethylene diisocyanate and/or of pentamethylene diisocyanate. In another preferred embodiment, the composition comprises polyaspartic esters as NCO-reactive compound, and as polyisocyanate a hexamethylene diisocyanate trimer and/or a pentamethylene diisocyanate trimer. The composition is preferably not a foamable or foam-forming composition. The composition is preferably not radically polymerizable, especially not photopolymerizable; that is, the composition does not cure through radical processes, especially not through radical polymerization processes which are initiated by actinic radiation. The composition may for example be a coating material or a coating. The composition is preferably a two-component composition (2K composition), meaning that the components are first prepared and stored separately and are not mixed with one another until shortly before or during application. After mixing, the components begin to react with one another. The working time at room temperature, also referred to as pot life, is then situated in the range from 1 minute up to 24 hours, depending on the components selected, and usually in the range from 10 minutes to 8 hours.

The composition of the indicator system of the invention is preferably a polyurethane and/or polyurea coating material, more preferably a polyurethane and/or polyurea refinish clearcoat, more preferably still a refinish clearcoat based on polyaspartic ester derivatives.

Additionally, the composition may comprise adjuvants typical for coating technology with polyisocyanate polyaddition compounds, especially for polyurethane compounds. Examples are catalysts/activators such as, for example, titanium, zirconium, bismuth, tin and/or iron-containing catalysts, as described in WO 2005/058996, for example. It is also possible to add amines or amidines.

Examples of further suitable adjuvants are, in particular, light stabilizers such as UV absorbers and sterically hindered amines (HALS), and also stabilizers, fillers and antisettling agents, defoaming, anticratering and/or wetting agents, leveling agents, film-forming auxiliaries, reactive diluents, solvents, substances for rheology control, slip additives and/or components which prevent soiling and/or improve the cleanability of the cured coatings, and also flatting agents.

The use of light stabilizers, especially of UV absorbers, for example substituted benzotriazoles, S-phenyltriazines or oxalanilides, and of sterically hindered amines, especially having 2,2,6,6-tetramethylpiperidyl structures—referred to as HALS—is described by way of example in A. Valet, Lichtschutzmittel für Lacke, Vincentz Verlag, Hanover, 1996.

Stabilizers such as, for example, free-radical scavengers and other polymerization inhibitors such as sterically hindered phenols, stabilize paint components during storage and are intended to prevent discoloration during curing. Additionally contemplated are water scavengers such as triethyl orthoformate or hydrolysis inhibitors such as carbodiimides.

The composition may further comprise pigments, dyes and/or fillers. The pigments used for this purpose including metallic or other effect pigments, dyes and/or tillers are known to those skilled in the art.

Preferred fillers are those compounds that have no adverse effect on the appearance of the coating. Examples are nanoparticles based on silicon dioxide, aluminum oxide or zirconium oxide; reference is also made additionally to the Römpp Lexicon “Lacke und Druckfarben” [Coatings and Printing Inks] Georg Thieme Verlag, Stuttgart, 1998, pages 250 to 252.

If there are fillers, flatting agents or pigments present, the addition of antisettling agents may be advisable to prevent separation of the constituents in the course of storage.

Wetting and leveling agents improve surface wetting and/or the leveling of coatings. Examples are fluoro surfactants, silicone surfactants and specific polyacrylates. Rheology control additives are important in order to control the properties of the two-component system on application and in the leveling phase on the substrate and are known, for example, from patent specifications WO 94/22968, EP-A-0 276 501, EP-A-0 249 201 or WO 97/12945; crosslinked polymeric microparticles are disclosed, for example, in EP-A-0 008 127; inorganic sheet silicates such as aluminum-magnesium silicates, sodium-magnesium and sodium-magnesium-fluorine-lithium sheet silicates of the montmorillonite type; silicas such as Aerosil®; or synthetic polymers having ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and derivatives thereof, or hydrophobically modified ethoxylated urethanes, ureas or polyacrylates.

The composition may further comprise solvents. The solvent may be an organic solvent or a mixture of organic solvents, or water or a mixture of organic solvent(s) and water. Suitable solvents should be used after matching to the composition and to the application process, in a manner known to those skilled in the art. Solvents are intended to dissolve the components used and promote the mixing thereof, and to avoid incompatibilities. In addition, during the application and the curing, they should leave the coating in a manner matched to the proceeding crosslinking reaction so as to afford a solvent-free coating with the best possible appearance and without defects such as popping or pinholes. Contemplated solvents include in particular those used in two-component technology. Examples of organic solvents are ketones such as acetone, methyl ethyl ketone or hexanone, esters such as ethyl acetate, butyl acetate, methoxypropyl acetate, substituted glycols and other ethers, aromatics such as xylene or solvent naphtha, for example from Exxon-Chemie, and mixtures of the solvents mentioned. Where the NCO-reactive part of the composition takes the form of an aqueous dispersion, water is also suitable as solvent or diluent.

The composition is produced by methods known per se in the technology of coating materials and printing inks. Isocyanate-reactive and isocyanate-containing components are first prepared separately by mixing the respective ingredients. Mixing only takes place immediately before or during application. Where mixing takes place before application, it should be borne in mind that the reaction of the constituents commences straight after mixing. The reaction will proceed at different rates depending on the selection of the components and of the adjuvants, so resulting in a pot life within which the composition must be applied. The components are selected and the pot life determined in accordance with methods known to those skilled in the art.

Examples of corresponding compositions are commercially available 2K PU coating materials, also known as DD coating materials. These coating materials are sold for applications in particular as surfacers, clearcoats or topcoats, as for example for automotive refinish, large-vehicle finishing, the coating of plastics, automotive finishing, general industrial coating, furniture coating, the coating of floors, or for coating in the building industry. Automotive refinish clearcoats are available, for example, under the name Permasolid® clearcoat and curing agent from Spies-Hecker GmbH, Cologne; and also under the name Glasurit® clearcoat and curing agent from BASF Coatings GmbH, Münster; and additionally under the names Deltron® and Nexa Autocolor® clearcoat and curing agent from PPG Deutschland Sales & Services GmbH, Hilden; and also under the names Sikkens Autoclear® from Akzo Nobel N.V., Amsterdam.

It is clear to those skilled in the art that the only compositions suitable for the indicator system of the invention are those which do not give rise to color interference with the color change of the indicator dye on curing. These are, in particular, clearcoat materials and also weakly colored or staining coatings, and also light-colored topcoats, especially white topcoats. Particularly preferred are unpigmented clearcoat materials. Interfering in this context means that the change in the color of the indicator dye is no longer visible to the human eye as a result of other pigments, dyes or fillers.

The term “proton source” refers in the sense of the present invention to a compound which by virtue of its acidic effect is able to carry out proportional or complete neutralization of basic components in the composition.

In one preferred embodiment, the at least one proton source is a Brønsted acid. The term “Brønsted acid” refers in the sense of the present invention to a compound which is capable of giving up protons in the manner of an acid-based reaction. The Brønsted acid is preferably selected from the group of organic acids, and more particularly is selected from the group consisting of nonpolymeric carboxylic acids, including hydroxycarboxylic acid, and also phosphoric and sulfonic acids with organic substitution.

Examples of suitable monocarboxylic acids include acids selected from the group consisting of benzoic acid, cyclohexanecarboxylic acid, 2-ethylhexanoic acid, caproic acid, caprylic acid, capric acid, lauric acid, and natural and synthetic fatty acids, especially lauric, myristic, palmitic, margaric, stearic, behenic, cerotinic, palmitoleic, oleic, icosenic, linoleic, linolenic and arachidonic acid.

Suitable dicarboxylic acids are those having a molecular weight in the range from 104 to 600 g/mol. Preferred dicarboxylic acids are selected from the group consisting of phthalic acid, isophthalic acid, tetrahydrophthalic acid, hexahydrophthalic acid, cyclohexanedicarboxylic acid, maleic acid, fumaric acid, malonic acid, succinic acid, glutaric acid, adipic acid, pimelic acid, suberic acid, sebacic acid, dodecanedoic acid, and hydrated dimers of fatty acids.

Additionally suitable are alpha-, beta- or gamma-hydroxycarboxylic acids such as, for example, malic acid, citric acid, 2-hydroxy-4-methylmercaptobutyric acid, glycolic acid, isocitric acid, mandelic acid, lactic acid, tartronic acid, tartaric acid, β-hydroxybutyric acid, mevalonic acid, gallic acid, 4-hydroxybutanoic acid, and 4-hydroxybenzoic acid.

Likewise suitable are oligomeric or polymeric compounds containing acidic groups, such as polyhydroxybutyric acid, acidic polyesters, or polymers of vinyl compounds into which acidic groups have been copolymerized by means, for example, of monomers such as acrylic acid or methacrylic acid.

Likewise suitable are sulfonic acids. The sulfonic acids are especially selected from the group of alkanesulfonic acids such as dodecylsulfonic acid or of arenesulfonic acids such as 4-dodecylbenzenesulfonic acid and 4-toluenesulfonic acid.

Likewise suitable are phosphoric acids. Suitable phosphoric acids are, in particular, partially esterified phosphoric acids, especially monoalkyl and/or dialkyl esters such as dibutyl phosphate or ethyl hexyl phosphate.

Where these are obtainable, with chiral acids both the respective enantiomers and the racemic forms are suitable.

Particularly preferred acids are those which at 23° C. are liquid and therefore capable of forming a film and having a pK_{A} of between 1 and 10, more particularly between 3 and 8. The pk_{A} may be determined by methods known to those skilled in the art. To those skilled in the art it is clear here that parameters such as solubility and solvent have an influence on the pk_{A}.

The term “indicator dye” refers in the sense of the present invention to a dye which on contact with the uncured composition of the indicator system of the invention exhibits a first color, and in the cured composition is colorless. In the present context, the term “color” or “hue” refers to that which is perceived by the human eye after absorption of one or more sub-regions within the range of the electromagnet spectrum that is visible to the human eye, from 380 to 780 nm. The hue may for example be red, yellow, green, and blue, or else a variation thereof with respect to chroma and lightness. The transition from the first color to colorless, i.e., the change in color, may be gradual or sudden. The change in color is preferably gradual, meaning that the chroma and/or lightness of the hue of the dye decrease until the dye is colorless. In the case of a sudden change in color (color switch) the decrease in the chroma and/or lightness of the dye is so rapid that it is no longer perceived with the human eye. In the present context, colorless means that no electromagnet radiation in the range of from 380 to 780 nm is absorbed. The human eye is unable to distinguish between the hue of the cured composition without indicator dye and that of the cured composition with indicator dye. More particularly this means that the difference deltaE, colorimetrically according to CIE-L*a*b system (DIN EN ISO 11664-4:2011), is less than 2.5, preferably less than 1.0.

If more than one indicator dye is used, the first color which occurs on contact with the composition is the color which forms as a result of the mixing of the colors of the individual indicator dyes used, after contact with the composition. In one variant, the different indicator dyes may become colorless at different degrees of curing; in other words, in a mixture of two indicator dyes, for example, the first indicator dye becomes colorless as soon as the composition has reached a first degree of curing, and the second dye becomes colorless only as soon as the composition has reached a second degree of curing. This is of interest in particular for applications where different degrees of curing of the composition allow different subsequent steps of work. For example, a first degree of curing may be reached when it is possible to coat the composition with a further composition, and a second degree of curing when it is possible to sand the composition. To those skilled in the art it is clear that in the fully cured composition, all the indicator dyes in the sense of the invention are colorless.

Depending on the indicator dye used, it is possible for different degrees of drying of the coating to be ascertained selectively. The degree of drying indicates the degree of curing of the composition according to DIN EN ISO 9117-5:2012. In accordance with the invention, the term “cured” means that in general at least 50% of the NCO groups, preferably 60%, more preferably 80%, have been consumed by reaction. The term “cured composition” means more particularly that the composition has attained a strength which is sufficient for its further processing. Examples of further processing are sanding, polishing, packing, mounting, laminating, printing, lasering, joining, coating, washing, cleaning, diecutting, stitching, winding, stacking, deforming, testing, subjecting to electric current, removing from a protected environment, or recoating; preferably, further processing is sanding, polishing and/or mounting.

A suitable indicator dye has at least one xanthene skeleton, preferably a fluoran skeleton. The indicator dye is preferably a fluorescein or rhodamine derivate. Particularly suitable in this context are those derivatives of xanthene and of fluoran that are able to form a spirolactone form. These are, in particular, those derivatives of xanthene and of fluoran which, on the central ring of the xanthene or fluoran skeleton, respectively, on the unannulated carbon (C9 carbon atom of the xanthene or fluoran skeleton), carry a substituent which contains a carboxylic acid group, allowing the carboxylic acid group to form a spirolactone, preferably in the form of a five-membered ring, with the unannulated carbon atom of the xanthene skeleton. The substituent on the unannulated carbon atom is preferably a 2-benzoyl radical or a 2-phenylacetyl radical. Examples include fluorescein and its derivatives and salts, and also rhodamine and its derivatives and salts, especially dibromofluorescein, diiodofluorescein, fluorescein-S-thioisocyanate, fluorescein diacetate, 4- and/or 5-aminofluorescein, 4,5,6,7-tetrachlorofluorescein, 2′,4′,5′,7′-tetrabromofluorescein (eosin Y), 2′,4′,5′,7′-tetraiodofluorescein (erythrosine B), 2′,4′,5′,7′-tetrabromo-3,4,5,6-tetrachlorofluorescein, 2′,4′,5′,7′-tetrabromo-3,4,5,6-tetrachlorofluorescein disodium salt (phloxin B), 3,4,5,6-tetrachloro-2′,4′,5′,7′-tetraiodofluorescein (Rose bengal), 3′,4′,5′,6′-tetrahydroxyspiro[2-benzofuran-3,9′-xanthen]-1-one (pyrogallolphthalein), 9-(2-carboxyphenyl)-3,6-bis(diethylamino)xanthylium chloride (rhodamine B), 5-carboxytetramethylrhodamine, and sulfodi-o-tolyldiamino-o-carboxyphenylxanthenene sodium salt (violamine R). Additionally suitable are the fluorescein derivatives described by Xian-Fu Zhang, Jianlong Zhang and Limin Liu in J. Fluoresc. (2014) 24:819-826. Additionally suitable are dyes which are employed in molecular biology as fluorescence probes and/or in fluorophore labeling and contain a xanthene skeleton and are able to form spirolactone form. Examples are compounds sold under the name Alexa Fluor® by Molecular Probes, Inc., Eugene, USA. Alexa Fluor® 488, 546 and 568 are suitable in particular. For all of the aforesaid dyes it is possible to employ insofar as chemically preparable not only the pure acids or bases but also salts thereof; such as sodium salts of the fluorescein derivatives or chlorides of the rhodamine derivatives, for example. Preferred dyes are those whose change in color on curing of the composition is readily visible with respect to the background and to any existing coloration of the composition. An example of such a change in color is the partial or preferably complete decoloring of a red dye, which on many substrates has better visibility for the eye than the decoloring of a yellow dye.

The at least one indicator dye is preferably selected from the group consisting of fluorescein derivatives and/or rhodamine derivatives, especially those which are able to form a spirolactone form, i.e. having on the central ring of the xanthene skeleton, on the unannulated carbon (C9 carbon atom of the xanthene skeleton), a substituent which comprises a carboxylic acid group, this carboxylic acid being able to form a spirolactone with said unannulated carbon atom. Particularly preferred are fluorescein derivatives which are able preferably to form a spirolactone form. Particularly preferred are 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof. Especially preferred is 3,4,5,6-tetrachloro-2′,4′,5′,7′-tetrabromofluorescein and also its disodium salt (phloxine B). The at least one indicator dye may additionally be mixed with auxiliaries and adjuvants such as solvents, stabilizers, fillers and also antisettling agents, defoaming, anticrater and/or wetting agents, dispersing assistants, leveling agents, film-forming assistants, and substances for rheology control.

Suitable solvents should be used in a form matched to the indicator dye and also to the composition and the application method, as is known to those skilled in the art. Solvents are intended to dissolve the indicator dye or dyes and to promote the mixing thereof—optionally also with the composition—and also to avoid incompatibilities. The indicator dyes are usually highly soluble in water and/or alcohols, and so these solvents are preferred.

In one preferred embodiment, the at least one indicator dye and the at least one proton source of the indicator system of the invention are mixed with auxiliaries and adjuvants according to customary techniques. It is preferred here for the at least one indicator dye and the at least proton source to be present in dissolved form, or for the at least one indicator dye to be deposited from dissolved form, allowing it to be brought back into solution as rapidly as possible and as completely as possible by the other constituents of the composition of the indicator system of the invention. In one preferred embodiment, the at least one indicator dye and the at least one proton source are mixed with at least one dispersing assistant which supports the redissolution of the deposited indicator dye.

In one preferred embodiment, the indicator system of the invention comprises a composition which comprises at least one NCO-reactive compound selected from the group consisting of polyaspartic esters, polyacrylate polyols, polyester polyols and/or mixtures of at least two thereof, and at least one polyisocyanate, the polyisocyanate being a derivative of hexamethylene diisocyanate and/or of pentamethylene diisocyanate, and comprises at least one proton source selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and comprises at least one indicator dye selected from the group of fluorescein and rhodamine derivatives which are able to form a spirolactone form. In a further preferred embodiment, the indicator system of the invention comprises a composition comprising at least one NCO-reactive compound, the NCO-reactive compound being a polyacrylate polyol or a polyaspartic ester, and at least one polyisocyanate, the polyisocyanate being a derivative of hexamethylene diisocyanate and/or the pentamethylene diisocyanate, at least one proton source selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and at least one indicator dye, the indicator dye being a fluorescein derivative which is able to form a spirolactone form. In a further preferred embodiment, the indicator system of the invention comprises a composition comprising at least one NCO-reactive compound, the NCO-reactive compound being a polyacrylate polyol or a polyaspartic ester, and at least one polyisocyanate, the polyisocyanate being a derivative of hexamethylene diisocyanate and/or the pentamethylene diisocyanate, at least one proton source selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and at least one indicator dye selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof. One particularly preferred combination of indicator dye and proton source is 3,4,5,6-tetrachloro-2′,4′,5′,7′-tetrabromofluorescein and also its disodium salt (phloxine B) in combination with lactic acid, preferably in its racemic form.

In one preferred embodiment of the invention, the at least one indicator dye and the at least one proton source are applied on the surface of an inert carrier. For this purpose, the at least one indicator dye and the at least one proton source are first applied to a carrier material. The carrier material comprising the at least one indicator dye and the at least one proton source is coated with the composition jointly with the substrate in a temporally and/or spatially separate step, so that the at least one indicator dye and the at least one proton source come into contact only with the coating on the carrier material, and not with the coating on the substrate. On contacting with the composition, the at least one indicator dye and the at least one proton source are parted from the carrier and they mix with the composition on the carrier material. The curing of the coating on the substrate is then reliably indicated by the change in color of the composition on the carrier material.

The amount of proton source added is governed by the amount of basic constituents such as, for example, basic light stabilizers (HALS) or basic polymers such as polyaspartic esters, for example, which are present in the composition. The proton source is intended to neutralize these constituents. The level of addition required should be ascertained, for example, by simple preliminary tests, in which the effect on the decoloring of the indicator dye is found by gradually raising the amounts of proton source added, with work subsequently continuing using at least the concentration which leads to complete decoloring in the course of curing. Preference is given to using between 0.05 and 2.00 wt % of proton source, based on the total mass of the composition.

The amount of indicator dye relative to the composition ought to be selected so that it is at least high enough to allow the decoloring to be monitored readily with the eye in the course of curing. On the other hand, it ought not to be so high that the addition of the indicator dye influences the curing, in the manner of a filler, for example. Generally speaking, indicator dye concentrations of between 5 and 5000 mg/kg are suitable, preferably between 50 and 1000 mg/kg, more particularly between 100 and 500 mg/kg, based on the pure indicator dye and on the nonvolatile constituents of the composition. The nonvolatile constituents can be determined according to DIN EN ISO 3251:2008 on a sample of 2.0 g in a forced air oven at 100° C. with a residence time of 120 minutes.

Suitable carriers and carrier materials are those on which the at least one indicator dye and the at least one proton source can be applied in such a way that on coating with the composition, they part from the carrier material again, are dissolved in the applied composition, and so indicate the curing of the coating or composition through a change in color of the at least one indicator dye. Suitable carrier materials are, for example, foils of plastic or metal, papers, cardboard, multilayer laminates of the aforesaid materials, and also of aforesaid materials coated with a fiberlike layer of—for example—cellulose, cotton, textile and/or glass fibers. Additionally, aforesaid materials provided with a coating film or adhesive layer to which the indicator dye is applied. Preferred carrier materials here are those with surfaces from which the at least one indicator dye and the at least one proton source go back most easily into the composition after the coating of the carrier material with the composition. Examples of these are polymeric foils, especially those of polyvinyl acetate, polyesters, polycarbonate or polymethyl methacrylate, more particularly of polycarbonate or polyethylene terephthalate. The foils may be smooth or may have rough, textured surfaces. The carrier material is preferably white at least on the surface to which the at least one indicator dye and the at least one proton source are applied, when the composition is a clearcoat, since changes in color can be discerned with particular ease by the human eye against a white background. If the composition is not a clearcoat, but is instead pigmented, then the carrier material is preferably transparent and uncolored, allowing a change in color to be observed with the eye through the carrier material. The inert carrier is preferably a polymer foil or a glass fiber web, more preferably a polymer foil, more particularly a polyethylene terephthalate foil or polycarbonate foil. In one preferred embodiment, the inert carrier is colorless and transparent.

In a further embodiment, the at least one indicator dye and the at least one proton source are applied on a first surface of an inert carrier, the inert carrier, by a second surface, which faces away from the first surface, being applied on a second inert carrier. Carriers contemplated for the second inert carrier are all those stated above. The second carrier is preferably selected from the group consisting of polymer foils, metal foils, paper and/or card. In one preferred embodiment, the first carrier is colorless and transparent, and the second carrier is white. This has the advantage of better visibility of the evolution in color by the indicator dye on curing of the composition.

In one preferred embodiment, the inert carrier is a polymer foil or a glass fiber web, the at least one proton source is selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and the at least one indicator dye is a fluorescein and/or rhodamine derivative which is able to form a spirolactone than, more particularly a fluorescein derivative which is able to form a spirolactone form. In another preferred embodiment, the inert carrier is a polymer foil, the at least one proton source is selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and the at least one indicator dye is selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof. In one preferred embodiment, the inert carrier is a polymer foil or a glass fiber web, the second inert carrier is selected from the group consisting of polymer foils, metal foils, paper and/or card, the at least one proton source is selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and the at least one indicator dye is a fluorescein and/or rhodamine derivative which is able to form a spirolactone form, more particularly a fluorescein derivative which is able to form a spirolactone form. In another preferred embodiment, the inert carrier is a polymer foil, the second inert carrier is selected from the group consisting of polymer foils, metal foils, paper and/or card and is preferably white, the at least one proton source is selected from the group consisting of monoalkyl and/or dialkyl esters of phosphoric acid such as dibutyl phosphate or ethyl hexyl phosphate, arenesulfonic acids such as 4-dodecylbenzenesulfonic acid, and liquid monocarboxylic acids such as 2-ethylhexanoic acid or lactic acid, and the at least one indicator dye is selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof.

The at least one indicator dye and the at least one proton source are applied by suitable techniques to at least one of the surfaces of the carrier material. Examples of application techniques include printing, spreading, rolling, pouring, knifecoating, roller coating, dipping and/or spraying, with rolling, knifecoating and printing being preferred. After application has taken place, any solvents present in the indicator dye are removed by customary drying techniques. The carrier material on which the at least one indicator dye and the at least one proton source are applied may be protected from damage during storage and transport by application of a temporary protective layer—for example, a polypropylene laminating foil. Furthermore, the carrier may, for example, comprise a pressure-sensitive adhesive layer on the side not coated with the at least one indicator dye and the at least one proton source, allowing the carrier to be affixed, for example, on a substrate or object or on a carrier for the substrate. The pressure-sensitive adhesive layer may optionally likewise be protected with a laminating foil during storage and transport.

The composition is applied by suitable techniques to a substrate or object and to the carrier material comprising the at least one indicator dye and the at least one proton source. Substrate and carrier material are located here preferably in direct spatial vicinity, and so the curing of the further constituents of the composition on the substrate, and the curing of the composition on the carrier material, take place under conditions that are as far as possible the same. For example, the carrier material may be fixed on the edge of the substrate or on a mount which holds the substrate during coating.

Techniques for applying the composition to substrate or object and to the carrier material comprising the at least one indicator dye and the at least one proton source are, for example, printing, spreading, roller coating, pouring, knifecoating, rolling, dipping, fluidized bed processes and/or, preferably, spraying, such as compressed air spraying, airless spraying, and high-speed rotary atomization, for example. Spray application may optionally be combined with electrostatic charging of the atomized particles (ESTA), and/or may optionally be combined with hot spray application, such as hot-air hot spraying or hot steam spraying, for example. For spraying techniques which utilize a gas for atomization and/or for transferring the atomized particles, suitable gases include not only air but also others such as nitrogen, carbon dioxide or steam, for example.

Suitable substrates or objects are, for example, substrates comprising one or more materials, including, in particular, those referred to as composite materials. A substrate formed from at least two materials is referred to in accordance with the invention as composite material. Suitable materials are, for example, wood, metal, plastic, paper, leather, textiles, felt, glass, woodbase materials, cork, rubber, linoleum, inorganically bound substrates such as wood and fiber cement boards, electronic assemblies or mineral substrates. Suitable types of composite material are, for example, particle composite materials, also referred to as dispersion materials, fiber composite materials, laminar composite materials, also referred to as laminates, penetration composite materials and structural composite materials.

Suitable metals are, for example, steel, aluminum, magnesium and alloys of metals as used in the applications of so-called wire coating, coil coating, can coating or container coating, and the like.

In the context of the invention, the term plastic also comprehends fiber-reinforced plastics, for example glass fiber- or carbon fiber-reinforced plastics, and plastics blends composed of at least two or more plastics. Examples of plastics suitable in accordance with the invention are ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations according to DIN 7728T1). These may also be in the form of films or in the form of glass fiber- or carbon fiber-reinforced plastics.

The substrates may have already been coated wholly or partly with one or more coating films. These coating films may still be uncured or damp, partly cured or fully cured; the further coating films on the substrate are preferably partly cured or fully cured. Examples of coating films are priming coats, primers, surfacers, filling coats, basecoats, or substrates which have already been fully painted and which are being recoated after possible pretreatment such as sanding or plasma activation. Especially suitable are substrates of the kind which occur in refinishing or finishing in the context of renovations or maintenance on vehicles, especially in the case of ships, aircraft, motor vehicles such as automobiles, trucks, coaches, large vehicles, rail vehicles.

The application of the composition of the indicator system of the invention is followed by the curing and/or the drying of this composition on the substrate or object and optionally on the carrier material. This takes place according to techniques which are customary in coating technology, either under ambient conditions in respect of temperature and atmospheric humidity, or under forced conditions, through—for example—temperature increase in ovens, use of radiation such as infrared or near-infrared or microwave radiation, for example, and use of dehumidified and/or heated air or other gases. It is preferred here to do without the use of apparatus for forced curing, or to use only an apparatus which allows the decoloring of the at least one indicator dye to be monitored with the human eye. During the curing of the composition, there is a gradual fading of the color of the at least one indicator dye, preferably to the point of colorlessness for the human eye, which therefore indicates that curing has taken place.

A further subject of the invention is a method for optically indicating the curing progress of a composition which comprises at least one NCO-reactive compound and at least one polyisocyanate, characterized in that the method comprises the following steps:
(a) providing at least one indicator dye and at least one proton source, the at least one indicator dye having at least one xanthene skeleton, and the at least one indicator dye and the at least one proton source being applied on the surface of an inert carrier,
(b) contacting the at least one indicator dye and the at least one proton source from step (a) with the uncured composition, the at least one indicator dye having a first color, and
(c) curing the composition, the at least one indicator dye indicating the curing of the composition through color switch from the first color to colorless.

The indicator system of the invention constitutes the composition used in the method of the invention and comprising at least one NCO-reactive compound and at least one polyisocyanate, and also the at least one indicator dye and the at least one proton source. The statements made above concerning further embodiments and preparation pathways and possible processing steps are valid analogously for the method of the invention.

The contacting of the at least one indicator dye and of the at least one proton source with the uncured composition may be accomplished, as described above, by prior application of the at least one indicator dye and of the at least one proton source to a carrier material, subsequent detachment from the carrier material, and mixing of the at least one indicator dye and the at least one proton source with the composition applied on the carrier.

In one preferred embodiment, the composition is applied to a substrate or object or the latter has been coated with the composition. With regard to the substrate or object, the statements made above concerning the nature of the substrate and the further embodiments are likewise valid.

In one preferred embodiment, the at least one indicator dye and the at least one proton source from step (a) are applied on the surface of an inert carrier, the inert carrier being a polymer foil or a glass fiber web, more preferably a polymer foil, more particularly a polyethylene terephthalate or polycarbonate foil. In a further preferred embodiment, the inert carrier is applied by a second surface, which faces away from the first surface, on a second inert carrier. The second carrier is preferably selected from the group consisting of polymer foils, metal foils, paper and/or card. In one preferred embodiment, the first carrier is colorless and transparent, and the second carrier is white. For the first and second carrier, the statements made above concerning the nature of the carriers and the further embodiments are likewise valid.

A further subject of the present invention is a method for optically ascertaining the curing progress of a composition comprising at least one NCO-reactive compound and at least one polyisocyanate, with at least one indicator dye and at least one proton source, the at least one indicator dye having at least one xanthene skeleton, characterized in that, after contacting of the at least one indicator dye and of the at least one proton source with the composition, the color of the at least one indicator dye is compared with a color scale in order to ascertain the curing progress.

The indicator system of the invention constitutes the composition used in the method of the invention and comprising at least one NCO-reactive compound and at least one polyisocyanate, and also the at least one indicator dye and the at least one proton source. The statements made above concerning further embodiments and preparation pathways and possible processing steps are valid analogously for the method of the invention.

The contacting of the at least one indicator dye and of the at least one proton source with the uncured composition may be accomplished, as described above, by prior application of the at least one indicator dye and of the at least one proton source to a carrier material, subsequent detachment from the carrier material, and mixing of the at least one indicator dye and the at least one proton source with the composition applied on the carrier.

This makes it possible first to examine a given composition and its curing with an indicator dye and to establish a correlation between the degree of cure and the intensity of coloration of the dye for a given concentration and film thickness. For the degree of curing it is possible, for example, to employ the determination of the degree of drying in accordance with DIN EN ISO 9117-5:2012. An additional possibility is to use drying time instruments or drying recorders such as the model from Byk-Gardner GmbH, Geretsried, DE, or the model 450 from Erichsen GmbH & Co. KG, Hemer, DE, which can operate in accordance with standards ASTM D 5895 (Jun. 1, 2013), ISO 9117-4:2012 and/or DIN EN 14022:2010 Simple trial and error can also be used to determine the earliest possible time for further processing such as, for example, sanding, polishing, packing, mounting, laminating, printing, lasering, joining, coating, washing, cleaning, diecutting, stitching, winding, stacking, deforming, testing, subjecting to electrical current, bringing out of a protected environment, or recoating. When the degree of decoloring has been determined by such preliminary tests, for a given composition and for the desired curing, the degree of curing necessary for further processing can be simply read off from the decoloring of the indicator system, on a repetition or on multiple coating of substrates, and accordingly the further processing can take place at the earliest technically rational time, without any need for further measurements or for the surface of the composition to be contacted. In one preferred embodiment, for comparing the desired decoloring, a corresponding reference surface is provided—for example, a white paper surface printed with a hue, or an area displayed in colored form on an electronic screen—on which the desired decoloring of the indicator system is specified in colored form and invariably. This can be done either through provision only of the single desired comparison hue, or by provision of a color scale, allowing the complete processing of decoloring to be monitored up to the desired degree of decoloring. In that case it is possible for the human eye to determine the earliest technically rational time for further processing, by a color comparison between the invariant color of the reference surface and the fading color of the indicator dye. Where a color scale is used, unambiguous marking of the corresponding hue, by means of letters or digits, for example, can be used to stipulate which hue the color of the indicator dye must fade to before the coated substrate is to be further-processed. The provision of the comparison hue or of the color scale may be accomplished in this case by customary printing techniques or by representation of customary screens suitable for color display.

A further subject of the present invention is a kit of parts comprising at least one indicator dye, the at least one indicator dye having at least one xanthene skeleton, at least one proton source and a composition comprising at least one NCO-reactive compound and at least one polyisocyanate, the at least one indicator dye and the at least one proton source preferably being applied on a first surface of an inert carrier, the inert carrier preferably being applied by a surface on a second inert carrier, the second carrier preferably being white.

The indicator system of the invention constitutes the composition used in the kit of parts of the invention and comprising at least one NCO-reactive compound and at least one polyisocyanate, and also the at least one indicator dye, the at least one proton source and the inert carrier. The statements made above concerning further embodiments and preparation pathways and possible processing steps are valid analogously for the kit of parts of the invention.

In one preferred embodiment, the above-described at least one indicator dye and the at least one proton source applied to a carrier material, including optional protective and/or adhesive layer or layers, may be used together with a color scale and, optionally, instructions for use as a kit of parts, together or separately to the composition. Preferably in this case the information regarding the color of the at least one indicator that corresponds to the earliest technically rational time for further processing is enclosed with the kit of parts or the composition. For example, a kit of parts comprising a color scale and a plurality of white foils coated with at least one indicator dye and with the at least one proton source can be included with a 2K PU clearcoat system for automotive refinish. Before the clearcoat is applied, the coater then mounts a foil, coated with at least one indicator dye and with the at least one proton source, on the carrier which holds the part to be coated, the mounting being such that upon coating the customary paint-gun cross-pass causes approximately the same amount of coating material that is applied to the substrate to land also on the foil bearing the at least one indicator dye and the at least one proton source. Upon fading of the color on the foil, with the aid of the color scale included in the kit of parts, as a reference, and with the aid of the target coloration ascertained and transmitted beforehand, by the coating material supplier, for example, the coater is able to ascertain when the desired degree of cure has been reached, allowing sanding and polishing to be commenced or allowing the vehicle to be parked in the open even under rain.

A further subject of the present invention is a method for increasing the cycle frequency between a coating step and a further downstream step in the processing of objects which are coated with a composition which comprises at least one NCO-reactive compound and at least one polyisocyanate, characterized in that at least one indicator dye is contacted with the composition in the presence of at least one proton source in order to indicate the curing progress of the coating, the at least one indicator dye having at least one xanthene skeleton.

The indicator system of the invention constitutes the composition used in the method of the invention and comprising at least one NCO-reactive compound and at least one polyisocyanate, and also the at least one indicator dye and the at least one proton source. The statements made above concerning further embodiments and preparation pathways and possible processing steps are valid analogously for the method of the invention.

The contacting of the at least one indicator dye and of the at least one proton source with the uncured composition may be accomplished, as described above, by prior application of the at least one indicator dye and of the at least one proton source to a carrier material, subsequent detachment from the carrier material, and mixing of the at least one indicator dye and the at least one proton source with the composition applied on the carrier.

Because the indicator system of the invention indicates the earliest technically rational time for further processing, by comparison with a color reference, it can be used to increase the cycle frequency in operations which require, for example, contactless determination of the degree of cure of a coating and in which contactless but apparatus-based determination of the degree of cure of a coating is undesirable or uneconomic. In place of an apparatus, use is made of the capacity of the human eye to allow hues to be compared with sufficient accuracy. A process comprising at least one coating step, at least one step of curing the coating or composition applied to at least one substrate in the coating step, and at least one step wherein the coated substrate is further-processed and for which the coating must be cured to a defined degree, can be accelerated in its cycle time through use of the indicator system. To those skilled in the art it is clear that the degree of curing of the coating or composition is dependent on the subsequent method step and/or the further processing. Examples of the subsequent method step or further processing are sanding, polishing, packing, mounting, laminating, printing, lasering, joining, coating, washing, cleaning, diecutting, stitching, winding, stacking, deforming, testing, subjecting to electrical current, bringing out of a protected environment, or recoating.

A further subject of the present invention is the use of an indicator dye with xanthene skeleton, preferably with fluoran skeleton, in the presence of at least one proton source, for optically indicating the curing progress of compositions comprising at least one NCO-reactive compound and at least one polyisocyanate, characterized in that the indicator dye has a first color after contacting with the uncured composition and in the sufficiently cured composition is colorless.

The indicator system of the invention constitutes the inventively used indicator dye, the at least one proton source, and the composition used that comprises at least one NCO-reactive compound and at least one polyisocyanate. The statements made above concerning further embodiments and preparation pathways and possible processing steps are valid analogously for the method of the invention.

The contacting of the indicator dye, in the presence of the at least one proton source, with the uncured composition may be accomplished, as described above, by prior application of the indicator dye and of the at least one proton source to a carrier material, subsequent detachment from the carrier material, and mixing of the indicator dye and of the at least one proton source with the composition applied on the carrier.

In one preferred embodiment, the composition is a polyurethane and/or polyurea coating material, preferably a polyurethane and/or polyurea refinish clearcoat, more preferably a refinish clearcoat based on polyaspartic ester derivatives.

Furthermore, the intention is to illustrate the present invention by means of the examples which follow.

### EXAMPLES

### 1) General Remarks

### 1.1) Determination of Drying Level in Accordance with DIN EN ISO 9117-5:2012

Using a four-way paint applicator, the coating material under test was drawn down on a glass plate. The measurement of time began with the act of drawdown.

Drying level 1 (T1) was awarded when, using a fine-hairbrush, it was possible to remove around 0.5 g of fine glass beads (diameter 2 mm) scattered over the surface.

For drying levels 2 to 4 (T2 to T4), the coating on a filter paper was loaded with different weights (T2 20 g, T3 200 g, T4 2 kg) for a duration of 60 seconds, after which the sample plate was dropped onto the bench top vertically from a height of about 30 mm. If the paper fell off, the drying level was reached.

Drying level 5 (T5) was tested as for drying level 4. For this level, however, there had to be no perceptible change in the surface of the loaded coating.

### 1.2) Color Values According to Color Scale

A color scale was drawn up, and then compared with the appearance of the coatings. The color scale was drawn up using the RGB color space provisions of the Microsoft® Excel® 2010 software (Format Cells/Fill/More Colors/Custom), with each hue being assigned a number in sequence of falling color intensity (from 1—really intensive magenta red to 14—colorless) and being printed out using a commercial printer (RICOH MP C 3003) on white paper (name IQ appeal 80 g/m² from Mondi Paper Sales Deutschland GmbH, Unterföhring, DE).

For the visual assessment, clearcoats were drawn down onto a colorless glass plate in a wet film thickness of 200 μm using a film-drawing frame (Byk-Gardner GmbH, Geretsried, DE). The coated glass plate was then placed onto a white paper sheet (manufacturer as above) and the hue was compared visually with the color scale during and/or after drying/curing.

TABLE 1
Color scale based on RGB color model

| Defined color value | Red | Green | Blue |
|---|---|---|---|
| 1 (strong red to | 230 | 0 | 126 |
| magenta) | | | |
| 2 | 255 | 21 | 149 |
| 3 | 255 | 41 | 158 |
| 4 | 255 | 63 | 168 |
| 5 | 255 | 83 | 177 |
| 6 | 255 | 101 | 185 |
| 7 | 255 | 121 | 194 |
| 8 | 255 | 143 | 204 |
| 9 | 255 | 163 | 213 |
| 10 | 255 | 183 | 222 |
| 11 | 255 | 201 | 231 |
| 12 | 255 | 221 | 240 |
| 13 | 255 | 243 | 250 |
| 14 (colorless) | 255 | 255 | 255 |

### 1.3) Chemicals Used

The following dyes were obtained from Sigma-Aldrich Chemie GmbH, Munich, DE, and used without further pretreatment:

Dye #1 (I=inventive): 2′,4′,5′,7′-Tetrabromo-3,4,5,6-tetrachlorofluorescein

Dye #2 (I): 2′,4′,5′,7′-Tetrabromofluorescein disodium salt (eosin Y)

Dye #3 (I): 2′,4′,5′,7′-Tetraiodofluorescein (erythrosine B)

Dye #4 (I): 3,4,5,6-Tetrachloro-2′,4′,5′,7′-tetraiodofluorescein (rose bengal)

Dye #5 (I): 2′,4′,5′,7′-Tetrabromo-3,4,5,6-tetrachlorofluorescein disodium salt (phloxine B)

Dye #6 (C=comparative example): 2,6-Diphenyl-4-(2,4,6-triphenyl-1-pyridinio)phenolate (Reichardt dye)

Dye #7 (C): 5-Amino-9-(diethylamino)benzo[a]phenoxazin-7-ium (Nile blue)

Dye #8 (C): 3,3-Bis(4-dimethylaminophenyl)-6-dimethylaminophthalide (crystal violet lactone)

Dye #9 (C): 3,7-Diamino-5-phenylphenazinium chloride (phenosafranine)

DBTL: Dibutyltin dilaurate, catalyst, CAS 77-58-7 (Aldrich, DE),

Setalux® D A HS 1272 (72% in butyl acetate): OH-containing polyacrylate polyol (Nuplex, NL),

MPA: 1-Methoxy-2-propyl acetate, CAS 108-65-6, solvent (BASF SE, DE),

Butyl acetate: Acetic acid n-butyl ester, CAS 123-86-4, solvent (BASF SE, DE),

Xylene: Solvent (Azelis, BE)

Diacetone alcohol: Solvent (Sigma-Aldrich, DE)

Desmodur® N 3600: Polyisocyanate based on trimers of hexamethylene diisocyanate, NCO content 23.0%, viscosity 1200 mPa s at 23° C. (Covestro Deutschland AG, DE),

Desmodur® N 3900: Polyisocyanate based on trimers of hexamethylene diisocyanate, NCO content 23.5%, viscosity 730 mPa s at 23° C. (Covestro Deutschland AG, DE),

Bentone® 38: organic derivative of a hectorite mineral for rheology control (Elementis Service Centre NV, NL),

Desmophen® NH 1420: Amino-functional reaction partner for polyisocyanates, amine number 200, viscosity 1500 mPa s at 23° C. (Covestro Deutschland AG, DE),

Desmophen® NH 1520: Amino-functional reaction partner for polyisocyanates, amine number 190, viscosity 1400 mPa s at 23° C. (Covestro Deutschland AG, DE),

Tinuvin® 292: “HALS” light stabilizer, sterically hindered amine, basic, Tinuvin® 384: Light stabilizer, UV absorber (both BASF SE, DE),

Aerosil® 300: hydrophilic fumed silica (Evonik Resource Efficiency GmbH, DE),

Makrofol® DE 1-1 000000, polycarbonate foil (Covestro Deutschland AG, DE)

Adhesive laminating foil GH-X173 natural (from Bischof u. Klein, Germany),

Dibutyl phosphate, racemic DL lactic acid, dodecylbenzenesulfonic acid: (all Sigma-Aldrich, DE)

Deltron Progress VHS Rapid D8135; curing agent 8214, activated diluent 8217: commercial automotive refinish clearcoat system, all PPG Sales and Services GmbH, DE

### 2) Examples

### 2.1) Example 1

Preparation of a clearcoat formulation with dye indicators, and application and drying thereof.

TABLE 2
Preparation of indicator dye solutions

| | | | | Diacetone | |
|---|---|---|---|---|---|
| Indicator | | Indicator | Amount of indicator | alcohol/dibutyl | Color of |
| solution | | dye | dye [mg] | phosphate 1:1 [g] | solution |
| 1 | (I) | # 1 | 46 | 10 | Red |
| 2 | (I) | # 2 | 54 | 10 | Orange |
| 3 | (I) | # 3 | 83 | 10 | Red |
| 4 | (I) | # 4 | 42 | 10 | Red |
| 5 | (I) | # 5 | 53 | 10 | Red |
| 6 | (C) | # 6 | 47 | 10 | Blue |
| 7 | (C) | # 7 | 42 | 10 | Blue |
| 8 | (C) | # 8 | 68 | 10 | Blue |
| 9 | (C) | # 9 | 54 | 10 | Red |

Key:
I = Inventive,
C = Comparative example

The indicator dyes prepared were first mixed with an isocyanate-reactive coating component by stirring. The perceived color of the solution was recorded after the end of the stirring procedure (table 4). Then an isocyanate-containing component was added and stirred in homogeneously, and the perceived color was recorded (table 4), and the coating material (see table 3) together with indicator dye was drawn down onto a colorless glass plate at 200 μm (wet) using a film-drawing bar, and the perceived color of the wet drawdown was recorded (table 4). The coating was dried at room temperature for 16 hours and changes in the color were monitored optically, until the coating was dry and hard. For comparison, in each case only the isocyanate-reactive component with indicator, but without isocyanate-containing component, was drawn down and dried. These drawdowns were still tacky after 16 hours. Furthermore, both the clearcoat with indicator and just the isocyanate-reactive component with indicator were each kept in a closed glass bottle, and the change in color was assessed visually after 16 hours. The isocyanate-reactive component kept in the bottle was still liquid. The clearcoat in the bottle reacted to form a viscous mass. The observed colors of the liquid and drawn-down coatings are set out in table 4.

TABLE 3
Composition of coating 1 - solventborne 2K PU clearcoat

| Coating 1 | Initial mass | |
|---|---|---|
| Isocyanate-reactive component | | |
| Setalux ® D A HS 1272 | 50.0 | g |
| Tinuvin ® 292 | 0.6 | g |
| Tinuvin ® 384 | 0.8 | g |
| Dibutyltin dilaurate | 1.6 | g |
| (1% solution in n-butyl acetate) | | |
| Mixture of Butyl acetate/1- | 12.6 | g |
| methoxyprop-2-yl acetate/xylene (1/1/1) | | |
| Indicator dye | 2.0 | g |
| Isocyanate-containing component | | |
| Desmodur ® N 3600 | 18.4 | g |
| Mixture of Butyl acetate/1- | 14.0 | g |
| methoxyprop-2-yl acetate/xylene (1/1/1) | | |
| Total (coating) | 100.0 | g |

TABLE 4
Observed colors of indicator dye solutions, of mixtures of the indicator dye solutions with
the NCO-reactive component and also with the composition in glass bottles and the coating
drawdowns-both immediately after mixing and after 16 h storage temperature.

| | 1-1 | 1-2 | 1-3 | 1-4 | 1-5 | 1-6 | 1-7 | 1-8 | 1-9 |
|---|---|---|---|---|---|---|---|---|---|
| Example | (I) | (I) | (I) | (I) | (I) | (C), | (V) | (C) | (C) |
| Indicator dye | #1 | #2 | #3 | #4 | #5 | #6 | #7 | #8 | #9 |
| Color of indicator dye | Red | Red | Red | Red | Red | Blue | Blue | Blue | Red |
| isolution | | | | | | | | | |
| Color of isocyanate- | Red | Red | Red | Red | Red | Brown | Violet | Blue | Red |
| reactive component | | | | | | | | | |
| with indicator dye | | | | | | | | | |
| solution immediately | | | | | | | | | |
| in the bottle | | | | | | | | | |
| Color of isocyanate- | Red | Red | Red | Red | Red | Brown | Violet | Blue | Red |
| reactive component | | | | | | | | | |
| with indicator dye | | | | | | | | | |
| solution in the bottle | | | | | | | | | |
| after 16 h | | | | | | | | | |
| Color of coating 1 | Red | Red | Red | Red | Red | Brown | Violet | Blue | Red |
| with indicator dye | | | | | | | | | |
| solution immediately | | | | | | | | | |
| in the bottle | | | | | | | | | |
| Color of coating 1 in | Red | Red | Red | Red | Red | Brown | Violet | Blue | Red |
| the bottle with | | | | | | | | | |
| indicator dye solution | | | | | | | | | |
| in the bottle after 16 h | | | | | | | | | |
| Glass drawdown, | Red | Red | Red | Red | Red | Green | Violet | Blue | Red |
| coating 1 immediately | | | | | | | | | |
| Glass drawdown, | Colorless | Colorless | Colorless | Colorless | Colorless | Green | Violet | Blue | Red |
| coating 1 after 16 hr | | | | | | | | | |

Examples 1-1 to 1-9 above show that all of the coatings when kept in the bottle react to form a viscous mass, owing to the inability of the solvents used to escape. In these cases there is no change in color.

Examples 1-1 to 1-5 according to the invention show that the coatings change color on drying and curing on a glass plate. The color intensities decrease over 16 hours. Coatings comprising the indicator dye #1, #2, #3, #4 and #5 are colorless after 16 h. The clearcoats containing the comparative dyes (solvatochrom #6; redox or pH indicators #7, #8, #9), on the other hand, do not change color during drying and curing of the coating.

### 2.2) Example 2

The coatings from example 1, with indicators #1, #3 and #4 added, were again drawn down to glass plates and dried at room temperature. On full decoloring of the coating (color value 14 according to color scale), the drying level of the coating was immediately determined (table 5).

TABLE 5
Determination of the drying level of coatings
with three different indicators

| Example 2-1 | | Example 2-2 | | Example 2-3 | |
|---|---|---|---|---|---|
| with coating 1 | | with coating 1 | | with coating 1 | |
| and indicator | Drying | and indicator | Drying | and indicator | Drying |
| dye | level | dye | level | dye | level |
| #1 | T3 | #2 | T1 | #3 | T1 |

Example 2 shows that different drying levels of the coatings can be indicated depending on the indicator dye of the invention that is selected.

### 2.3) Example 3

Where two indicator dye mixtures were prepared: As comparative [indicator #10(C)], 40 g of Aerosil® 300 were stirred using a dissolver into 380 g of diacetone alcohol, initially at a slow dissolver speed, followed by homogenization at 1000 rpm for 30 minutes. 0.05 g of indicator dye #1 was dissolved in 10.8 g of this mixture. In accordance with the invention [indicator #11(I)], 0.17 g of indicator dye #1 was dissolved in 40.0 g of the above mixture of diacetone alcohol and Aerosil, and 1.46 g of dibutyl phosphate were added. The coatings described in table 6 were subsequently prepared by mixing of the components. The last component to be added was the isocyanate-containing component, and immediately thereafter the coatings were drawn down onto a colorless glass plate at 200 μm (wet) using a film-drawing bar. The coating was dried at room temperature for 16 hours and changes in the color were monitored optically, until the coating was dry and hard.

TABLE 6
Effect of acid on the indicators in different coatings

| | Example | | Example | | Example | |
|---|---|---|---|---|---|---|
| Coating | 3-1 (C) | | 3-2 (C) | | 3-3(I) | |
| Isocyanate-reactive component | | | | | | |
| Setalux ® D A HS 1272 | 7.5 | g | 7.5 | g | 7.5 | g |
| Tinuvin ® 292 | | | 0.1 | g | 0.1 | g |
| Dibutyltin dilaurate | 0.3 | g | 0.3 | g | 0.3 | g |
| (1% solution in n-butyl acetate) | | | | | | |
| Mixture of Butyl acetate/1-meth- | 3.3 | g | 3.3 | g | 3.3 | g |
| oxyprop-2-yl acetate/xylene (1/1/1) | | | | | | |
| Indicator #10(C) | 3.0 | g | 3.0 | g | | |
| Indicator #11(I) | | | | | 3.0 | g |
| Isocyanate-containing component | | | | | | |
| Desmodur ® N 3600 | 2.8 | g | 2.8 | g | 2.8 | g |
| Total (coating) | 16.9 | g | 17.0 | g | 17.0 | g |

| Film drawdown, glass plate | Perceived colors according | | |
|---|---|---|---|
| (200 μm wet), drying at RT | to color scale as per table 1 | | |
| Starting value | 3 | 2 | 4 |
| after 1 h | 8 | 4 | 7 |
| after 1.5 h | 9 | 4 | 12 |
| after 3 h | 12 | 4 | 14 |
| after 5 h | 14 | 4 | 14 |
| after 16 h | 14 | 4 | 14 |

From comparative examples 3-1 and 3-2 it can be seen that adding a basic light stabilizer (Tinuvin® 292) disrupts the indicator system, and so the coating 3-2 no longer fades out. Only the indicator system of the invention fades out as drying progresses even with the light stabilizer present.

### 2.4) Example 4

An indicator dye solution was prepared by dissolving 55 mg of indicator dye #5 in 3.63 g of diacetone alcohol and 3.63 g of 1-methoxypropy-2-yl acetate. This solution was admixed with 2.00 g of Bentone® 38 and 0.7 g of dibutyl phosphate, which were stirred in. This suspension was drawn down uniformly using a 0.5 wire-wound coating bar onto a smooth polycarbonate foil of MAKROFOL® DE 1-1 000000 (1 mm thick). The foil was then dried in a forced air oven at 95° C. for 5 minutes. The resulting coated foil was uncolored, with a matt surface. On the side coated with dye, the foil was subsequently lined with an adhesive laminating foil GH-X173 natural (from Bischof u. Klein, Lengerich, Germany). The foil assembly was cut using scissors into strips with a length of 15 cm and a width of 15 cm.

Following removal of the laminating foils, the coating 1 from example 1, albeit without addition of an indicator, was drawn down on a foil strip. Over the course of 10 to 30 seconds, the coating turned red. This was followed by drying at room temperature. In the course of drying, the color of the coating was checked at defined times against the color scale as per table 1 (table 7). After 240 minutes, the coating was assessed as having a drying level of T4.

TABLE 7
Change in color values according to the color scale
as per table 1, over time, of coating 1 without indicator
dye, drawn down onto polycarbonate foil precoated
with indicator dye, during drying and curing

| | |
|---|---|
| | Defined color values |
| Time | according to color scale |

| 0.0 | min [start] | 14 | (colorless) |
|---|---|---|---|
| 0.5 | min | 5 | (red) |
| 30 | min | 6 | |
| 60 | min | 10 | |
| 90 | min | 12 | |
| 180 | min | 13 | |
| 210 | min | 13 | |
| 240 | min | 14 | (colorless) |

The example above shows that it is also possible to apply the indicator dye to a carrier; where the carrier is subsequently coated with a clearcoat, the latter first takes on color and then decolors again during drying and curing.

### 2.5) Example 5

Coating of a glass plate, precoated with indicator, with a coating material based on a polyaspartic ester and a polyisocyanate.

Where two indicator dye mixtures were prepared: 60 g of Bentone® 38 were stirred into 240 g of diacetone alcohol using a dissolver, initially at a slow dissolver speed, followed by homogenization at 200 rpm for 30 minutes. First, 0.05 g of indicator dye #1 was dissolved in 10.0 g of this mixture [comparative indicator #12(C)], and secondly 0.05 g of indicator dye #1 and 4-dodecylbenzenesulfonic acid were dissolved in 9.4 g of this mixture [indicator #13(I)]. The indicator dye mixtures were each applied to a colorless glass plate in a wet film thickness of 50 μm using a wire-wound coating bar. The coated glass plates were dried in a forced air oven at 95° C. for 5 minutes. The coating described in table 8 was subsequently produced by mixing of the components. The last component to be added was the isocyanate-containing component, and immediately thereafter the coating was drawn down using a film-drawing bar at 200 μm (wet) onto the indicator dye layer of the two previously coated glass plates. The coating was dried at room temperature for 4 hours and changes in the color were monitored optically. The coating was dry after about 1 hour and hard (fingerprint no longer visible) after 2.5 hours.

TABLE 8
Effect of acid on the indicators in different coatings

| | | |
|---|---|---|
| | Example | Example |
| Coating | 5-1 (C) | 5-2 (I) |

| | | | | |
|---|---|---|---|---|
| Isocyanate-reactive component | | | | |
| Desmophen ® NH 1420 | 7.1 | g | 7.5 | g |
| Desmophen ® NH 1520 | 2.4 | g | 2.4 | g |
| Tinuvin ® 292 | 0.1 | g | 0.1 | g |
| Butyl acetate | 4.6 | g | 4.6 | g |
| Isocyanate-containing component | | | | |
| Desmodur ® N 3900 | 5.9 | g | 5.9 | g |
| Total (coating) | 20.1 | g | 20.1 | g |

| Film drawdown, glass plate (200 μm | Indicator | Indicator |
|---|---|---|
| wet), precoated with: Drying at RT | #12(C) | #13(I) |
| Starting value (after 5 min) | 4 | 4 |
| after 0.5 h | 5 | 9 |
| after 1 h | 6 | 11 |
| after 2 h | 6 | 12 |
| after 3 h | 6 | 13 |
| after 4 h | 6 | 13 |

Only in the case of inventive example 5-2, with acid in the indicator dye mixture, is there fade-out of the coating on the glass plate. In the comparative example, the same coating without acid in the indicator dye mixture, in spite of the dye being the same, does not change.

### 2.6) Example 6

An indicator dye mixture was prepared by dissolving 100 mg of indicator dye #5 in 7.26 g of diacetone alcohol and 7.26 g of 1-methoxypropy-2-yl acetate. This solution was admixed with 4.00 g of Bentone® 38 and 1.24 g of racemic lactic acid, and the mixture was homogenized. This mixture was drawn down onto a foil and dried as in example 4. A section of this foil measuring 15 cm times 15 cm was mounted on a substrate carrier in a coating booth, using double-sided adhesive tape, such that the section of foil was also coated during the clearcoat finishing of a metal panel precoated with primer and basecoat. A commercial 2K PU clearcoat from PPG Sales and Services GmbH, DE (Deltron Progress UHS Rapid D8135; curing agent 8214, activated diluent 8217, mixing ratio 3:1:0.6) was applied as detailed in the technical sheet RLD212V of December 2008, in a dry film thickness of 50 μm, using a compressed-air spray gun. The coated panel and the coated foil were dried at room temperature for 3.5 hours.

The foil thus coated was assessed for its color development according to the color scale, and in parallel the curing of the clearcoat on the panel was assessed (table 9).

TABLE 9
Color development of a foil coated with a commercial automotive
refinish clearcoat, and coated beforehand with indicator dye,
and evolution of curing of the simultaneously coated metal panel

| Color evolution of | Color according | |
|---|---|---|
| coating on foil | to scale | Curing on panel |
| Starting value (after 5 min) | 7 | tacky |
| after 0.5 h | 10 | slightly tacky |
| after 1 h | 12 | dry to touch |
| after 2.5 h | 13 | dry |
| after 3.5 h | 13 | hard |

The example shows that the curing of the coating on the panel can also be indicated by the evolution in color of the co-coated foil which had been precoated with indicator.

1.-15. (canceled)

16. An indicator system comprising a composition which comprises at least one NCO-reactive compound and at least one polyisocyanate, and comprising at least one proton source and at least one indicator dye, the at least one indicator dye having at least one xanthene skeleton, for indicating the curing of the composition by change in color of the at least one indicator dye, wherein the at least one indicator dye, has a first color after contacting with the uncured composition and in the cured composition is colorless.

17. The indicator system as claimed in claim 16, wherein the at least one indicator dye and the at least one proton source are applied on a surface of an inert carrier, the inert carrier optionally being applied with a second surface, which faces away from the first surface, on a second inert carrier, the second carrier preferably being selected from the group consisting of polymer foils, metal foils, paper and/or card, and the inert carrier being colorless and transparent, and the second carrier preferably being white.

18. The indicator system as claimed in claim 16, wherein the at least one indicator dye has at least one fluoran skeleton.

19. The indicator system as claimed in claim 16, wherein the at least one proton source is a Brønsted acid.

20. The indicator system as claimed in claim 19, wherein the Brønsted acid is selected from the group consisting of nonpolymeric carboxylic acids, hydroxycarboxylic acids, phosphoric and sulfonic acids with organic substitution, and mixtures thereof.

21. The indicator system as claimed in claim 16, wherein the at least one polyisocyanate in the composition is an aliphatic and/or cycloaliphatic polyisocyanate.

22. The indicator system as claimed in claim 16, wherein the at least one NCO-reactive compound is selected from the group consisting of polyaspartic esters, polyacrylate polyols, polyester polyols, and mixtures thereof.

23. The indicator system as claimed in claim 16, wherein the composition is a polyurethane and/or polyurea coating material.

24. A method for optically indicating the curing progress of a composition which comprises at least one NCO-reactive compound and at least one polyisocyanate, wherein the method comprises the following steps:
(a) providing at least one indicator dye and at least one proton source, the at least one indicator dye having at least one xanthene skeleton, and the at least one indicator dye and the at least one proton source being applied on a surface of an inert carrier,
(b) contacting the at least one indicator dye and the at least one proton source from step (a) with the uncured composition, the at least one indicator dye having a first color, and
(c) curing the composition, the at least one indicator dye indicating the curing of the composition through color switch from the first color to colorless.

25. The method as claimed in claim 24, the inert carrier being a polymer foil or a glass fiber web.

26. The method as claimed in claim 24, wherein the inert carrier, by a second surface, which faces away from the first surface, is applied on a second inert carrier.

27. A method for optically ascertaining the curing progress of a composition comprising at least one NCO-reactive compound and at least one polyisocyanate, with at least one indicator dye and at least one proton source, the at least one indicator dye having at least one xanthene skeleton, wherein, after contacting of the at least one indicator dye and of the at least one proton source with the composition, the color of the at least one indicator dye is compared with a color scale in order to ascertain the curing progress.

28. A method comprising utilizing an indicator dye with xanthene skeleton, in the presence of at least one proton source, for optically indicating the curing progress of compositions comprising at least one NCO-reactive compound and at least one polyisocyanate, wherein the at least one indicator dye has a first color after contacting with the uncured composition and in the sufficiently cured composition is colorless.

29. A kit of parts comprising at least one indicator dye, the at least one indicator dye having at least one xanthene skeleton, at least one proton source, a composition comprising at least one NCO-reactive compound and at least one polyisocyanate.

30. A method for increasing the cycle frequency between a coating step and a further downstream step in the processing of objects which are coated with a composition which comprises at least one NCO-reactive compound and at least one polyisocyanate, wherein at least one indicator dye is contacted with the composition in the presence of at least one proton source in order to indicate the curing progress of the coating, the at least one indicator dye having at least one xanthene skeleton.
